(19) United States
(12) Patent Application Publication
(10) Pub. No.: US 2011/0306727 A1
(43) Pub. Date: Dec. 15, 2011

(54) AQUEOUS POLYMER DISPERSION

(75) Inventors: Hans Georg Grablowitz, Koeln (DE); Rolf Gertzmann, Leverkusen (DE); Dirk Achten, Leverkusen (DE); Maria Almato Guiteras, Barcelona (ES); Joan Miguel Garcia Martinez, Barcelona (ES)

(73) Assignee: BAYER MATERIALSCIENCE AG, Leverkusen (DE)

(21) Appl. No.: 13/145,510

(22) PCT Filed: Jan. 13, 2010
(86) PCT No.: PCT/EP10/00122

§ 371 Date: Jul. 20, 2011

(30) Foreign Application Priority Data
Jan. 22, 2009 (EP) 09000845.9

(51) Int. Cl. C09D 167/00; C08K 5/521

(52) U.S. Cl. 524/710; 524/833

(57) ABSTRACT

The present invention relates to aqueous polymer dispersions having a core-shell structure, to a method for the production thereof and to the use thereof as a coating agent.

The present invention relates to aqueous polymer dispersions having a core-shell structure, to a process for their preparation, and to their use as coating compositions.

Multi-phase, aqueous polyacrylate binders have already been known for a relatively long time. In such binders, the phases often have different glass transition temperatures (T_{g}). The products are often prepared in a two-stage polymerisation by polymerising two different monomer mixtures in succession in a radical emulsion polymerisation, the phases forming within the same dispersion particles owing to the mechanistics of the emulsion polymerisation.

Film formation of the polyacrylate coating compositions takes place, according to the substrate and glass transition temperature, at elevated temperature or at room temperature with the aid of a cosolvent, which acts as an internal plasticiser.

In order that the coatings exhibit as high a resistance to solvents as possible, high glass transition temperatures of the polymer are generally advantageous because the rate of diffusion of solvents is considerably lower below the glass transition temperature of the coating.

The multi-phase structure with different glass transition temperatures offers the advantage of a comparatively low minimum film-forming temperature (MFT) and, associated therewith, a relatively low content of cosolvent for film formation, the solvent resistance being comparatively high owing to the phase having a high glass transition temperature.

The use of binders which have as low a hydrophilicity as possible yields advantages with regard to the resistance of the coatings towards polar solvents such as water or alcohols. The hydrophilicity of the coating composition is given by the composition of the polymer, monomers such as styrene being regarded as hydrophobic and potentially ionic monomers such as acrylic acid being considered to be strongly hydrophilic.

In emulsion polymerisation, external emulsifiers are added in order to emulsify the free monomer during the polymerisation, to stabilise the growing particles, and formation of the polymerisation centres occurs by micelle formation at the beginning of the process. However, after application of the binder and subsequent film formation, the emulsifier migrates to the surface of the coating, which is frequently associated with disadvantages in terms of application.

EP-A 0 376 096 describes coating compositions which have a glass transition temperature of the core of greater than 60° C. and a shell having a glass transition temperature of greater than 80° C. The dispersions contain less than 20.2 wt. % monovinylaryl compounds and more than 4.5 wt. % methacrylic acid. The amount of added emulsifier, based on the solids, is always >2 wt. %.

WO-A 01/72897 describes aqueous, multi-phase coating compositions which consist of a soft core having a glass transition temperature<20° C. and a hard shell having a glass transition temperature of >60° C. The dispersions form a closed film at room temperature and do not contain styrene.

DE-A 19,727,504 discloses aqueous polymer dispersions in which the glass transition temperature of the core is less than or equal to the glass transition temperature of the shell, the acid content of the shell being >5 wt. %.

EP-A 1 520 865 describes core-shell particles wherein the shell has a glass transition temperature of >−9° C. and the difference with respect to the glass transition temperature of the core is at least 20° C. The emulsifier content of the examples is 3.0 wt. %.

It is an object of the present invention to provide finely divided, aqueous polyacrylate dispersions which have high solvent resistance, in particular ethanol and mustard resistance, while having a low content of coalescence aids. Moreover, the coatings produced therefrom are to have a good visual film appearance and should not exhibit surface defects or coating imperfections.

It has now been found that the above-defined object is achieved by aqueous polyacrylate dispersions which have a core-shell structure with a defined weight ratio of core and shell, wherein the core and the shell have defined glass transition temperature ranges and the dispersions contain only small amounts of emulsifier.

Accordingly, the present application provides aqueous polymer dispersions containing at least one core copolymer A) and at least one shell copolymer B), characterised in that the glass transition temperature (T_{g}) of the core is from 70° C. to 100° C., the glass transition temperature (T_{g}) of the shell is from 20° C. to 55° C. and the overall glass transition temperature (T_{g}) of the core-shell copolymer is from 30° C. to 80° C., and the dispersion contains an emulsifier content in an amount of 1.5 wt. %, based on the solids.

The expression glass transition temperature used in this invention means the temperature at which the polymer changes from a glass-like state to a state of higher segment mobility of the polymer chain. The glass transition temperature of random copolymers can be calculated according to the Fox equation (Bulletin of the American Physical Society 1, 3, page 123, 1956):

$$\frac{1}{{T}_{g}} = \frac{{w}_{1}}{{T}_{g ( 1 )}} + \frac{{w}_{2}}{{T}_{g ( 2 )}} + … \frac{{w}_{i}}{{T}_{g ( i )}} + … \frac{{w}_{n}}{{T}_{g ( n )}}$$

wherein T_{g(i)} denotes the glass transition temperature of the respective homopolymer i of n monomers and wᵢ denotes the amount by weight of the monomer i, wherein the sum of all the amounts by weight w₁+w₂+ . . . wᵢ+ . . . wₙ=1.

Unless indicated otherwise, all glass transition temperatures mentioned in the present invention relate to the glass transition temperatures calculated according to the Fox equation.

The experimental glass transition temperature (T_{g}) of polymers can be determined in a known manner, for example by means of differential scanning calorimetry (DSC).

The polymer particles contained in the dispersions according to the invention have a mean particle size of from 75 to 140 nm, preferably from 80 to 125 nm, particularly preferably from 90 to 110 nm.

The copolymers A) and B) used according to the invention can be in the form of physical mixtures or, preferably, in the form of multi-stage polymers. The multi-stage polymerisation is begun with the preparation of the core copolymer A), followed by the preparation of the shell copolymer B).

The expression “core-shell particles” is very well known from the prior art and, within the context of the present invention, denotes polymers which are obtainable by multi-stage emulsion polymerisation. This process has already been known for a long time from the prior art and is described and discussed, for example, in Houben-Weyl, Volume E20, Part 2 (1987), p. 1150 ff. The person skilled in the art can also find further valuable references in publications U.S. Pat. No. 3,793,402, DE-A 41 21 652, DE-A 41 36 993, EP-A 828 772, to the disclosures of which explicit reference is hereby made.

The monomer mixture of copolymer A) (core) has a glass transition temperature (T_{g}), calculated according to the Fox equation, of from 70 to 100° C., preferably from 80 to 100° C., particularly preferably from 85 to 95° C.

The T_{g}, calculated according to Fox, of the monomer mixture of copolymer B) (shell) is from 20 to 55° C., preferably from 25 to 45° C., particularly preferably from 25 to 35° C.

The T_{g} of copolymer B) is at least 30° C. lower, preferably at least 50° C. lower, than the T_{g} of copolymer A).

The calculated overall Tg of the polymer is given mathematically according to Flory Fox, the Tg of the polymers according to the invention preferably being from 30 to 80° C., preferably from 35 to 70° C. and particularly preferably from 40 to 65° C.

Copolymer A) contains as structural components
a) C₁-C₂₀-alkyl (meth)acrylates,
b) vinyl aromatic compounds having up to 20 carbon atoms,
c) acid-functional monomers and
d) optionally hydroxy-functional monomers.

The monomer mixture of copolymer A) is preferably composed of components a), b), c) and optionally d) in such a manner that the resulting glass transition temperature (T_{g}), calculated according to the Fox equation, is from 70 to 100° C., preferably from 80 to 100° C., particularly preferably from 85 to 95° C.

The monomer mixture of copolymer B) is preferably composed of components a), b), c) and optionally d) in such a manner that the resulting glass transition temperature (T_{g}), calculated according to the Fox equation, is from 20 to 55° C., preferably from 25 to 45° C., particularly preferably from 25 to 35° C.

Within the context of the present invention, the notation “(meth)acrylates” denotes acrylates, methacrylates and mixtures of the two. Suitable esters of methacrylic acid include in particular methyl methacrylate, ethyl methacrylate, propyl methacrylate, isopropyl methacrylate, n-butyl methacrylate, sec-butyl methacrylate, tert-butyl methacrylate, pentyl methacrylate, hexyl methacrylate, heptyl methacrylate, octyl methacrylate, 2-octyl methacrylate, ethylhexyl methacrylate, nonyl methacrylate, 2-methyloctyl methacrylate, 2-tert-butylheptyl methacrylate, 3-isopropylheptyl methacrylate, decyl methacrylate, undecyl methacrylate, 5-methylundecyl methacrylate, dodecyl methacrylate, 2-methyldodecyl methacrylate, tridecyl methacrylate, 5-methyltridecyl methacrylate, tetradecyl methacrylate, pentadecyl methacrylate, hexadecyl methacrylate, 2-methylhexadecyl methacrylate, heptadecyl methacrylate, 5-isopropylheptadecyl methacrylate, 5-ethyloctadecyl methacrylate, octadecyl methacrylate, nonadecyl methacrylate, eicosyl methacrylate, cycloalkyl methacrylates, such as, for example, cyclopentyl methacrylate, cyclohexyl methacrylate, 3-vinyl-2-butylcyclohexyl methacrylate, cycloheptyl methacrylate, cyclooctyl methacrylate, bornyl methacrylate, tetrahydrofurfuryl methacrylate and isobornyl methacrylate. Furthermore, the methacrylic acid derivatives can also be used in the form of the corresponding nitriles or amides, such as, for example, methacrylonitrile or methacrylamide. In addition, it is possible to use other functional monomers, depending on the desired application, such as, for example, diacetone methacrylamide or acetoacetoxyethyl methacrylate. Preference is given to methyl methacrylate, ethyl methacrylate, butyl methacrylate, tert-butyl methacrylate, methacrylamide or methacrylonitrile, and particular preference is given to methyl methacrylate, tert-butyl methacrylate or butyl methacrylate.

Suitable esters of acrylic acid include in particular methyl acrylate, ethyl acrylate, propyl acrylate, isopropyl acrylate, n-butyl acrylate, sec-butyl acrylate, tert-butyl acrylate, pentyl acrylate, hexyl acrylate, heptyl acrylate, octyl acrylate, 2-octyl acrylate, ethylhexyl acrylate, nonyl acrylate, 2-methyl-octyl acrylate, 2-tert-butylheptyl acrylate, 3-isopropylheptyl acrylate, decyl acrylate, undecyl acrylate, 5-methylundecyl acrylate, dodecyl acrylate, 2-methyldodecyl acrylate, tridecyl acrylate, 5-methyltridecyl acrylate, tetradecyl acrylate, pentadecyl acrylate, hexadecyl acrylate, 2-methylhexadecyl acrylate, heptadecyl acrylate, 5-isopropylheptadecyl acrylate, 5-ethyloctadecyl acrylate, octadecyl acrylate, nonadecyl acrylate, eicosyl acrylate, cycloalkyl acrylates, such as, for example, cyclopentyl acrylate, cyclohexyl acrylate, 3-vinyl-2-butylcyclohexyl acrylate, cycloheptyl acrylate, cyclooctyl acrylate, bornyl acrylate, tetrahydrofurfuryl acrylate and isobornyl acrylate. Furthermore, the acrylic acid derivatives can also be used in the form of the corresponding nitriles or amides, such as, for example, acrylonitrile or acrylamide. In addition, it is possible to use other functional monomers, depending on the desired application, such as, for example, diacetone acrylamide or acetoacetoxyethyl acrylate. Preference is given to ethyl acrylate, n-butyl acrylate, ethylhexyl acrylate, cyclohexyl acrylate, acrylamide or acrylonitrile, and particular preference is given to ethyl acrylate, n-butyl acrylate or ethylhexyl acrylate.

Suitable vinyl aromatic compounds b) having up to 20 carbon atoms are, for example, styrene, vinyltoluene, o- and p-methylstyrene, α-butylstyrene, 4-n-butylstyrene, 4-n-decylstyrene, halogenated styrenes, such as, for example, monochlorostyrenes, dichlorostyrenes, tribromostyrenes or tetrabromostyrenes. Styrene is preferred.

Suitable olefinically unsaturated, acid-functional monomers c) are sulfone-, phosphate- or carboxylic acid-functional monomers, preference being given to carboxylic acid-functional monomers such as acrylic acid, methacrylic acid, β-carboxyethyl acrylate, crotonic acid, fumaric acid, maleic anhydride, itaconic acid or monoalkyl esters of dibasic acids or anhydrides such as, for example, maleic acid monoalkyl esters. Particular preference is given to acrylic or methacrylic acid, and acrylic acid is most particularly preferred.

Also suitable as compounds of component c) are unsaturated, radically polymerisable compounds having phosphate or phosphonate or sulfonic acid or sulfonate groups, as are described, for example, in WO-A 00/39181 (p. 8, 1. 13-p. 9, 1. 19).

Hydroxy-functional monomers d) can optionally also be used. Suitable methacrylate compounds are those which carry a hydroxy function. These include, for example, hydroxyethyl methacrylate, hydroxypropyl methacrylate and hydroxybutyl methacrylate. Suitable compounds d) are also acrylate compounds which carry a hydroxy function; these include, for example, hydroxyethyl acrylate, hydroxypropyl acrylate and hydroxybutyl acrylate.

The content of monomers a) in copolymer A) is from 20 to 80 wt. %, preferably from 40 to 60 wt. %, the content of monomers b) in copolymer A) is from 19 to 79 wt. %, preferably from 37 to 57 wt. %, the content of monomers c) in copolymer A) is from 1 to 10 wt. %, preferably from 2 to 8 wt. %, and the content of monomers d) in copolymer A) is <30 wt. %, preferably <20 wt. %, the sum of components a), b), c) and optionally d) being 100 wt. %.

The content of monomers a) in copolymer B) is from 35 to 90 wt. %, preferably from 60 to 80 wt. %, the content of monomers b) in copolymer B) is from 9.9 to 60 wt. %, preferably from 19 to 37 wt. %, the content of monomers c) in copolymer B) is from 0.1 to 3.7 wt. %, preferably from 1 to 3.2 wt. %, and the content of monomers d) in copolymer B) is <30 wt. %, preferably <20 wt. %, the sum of components a), b), c) and optionally d) being 100 wt. %.

The weight ratio of the monomers of copolymer A) to the monomers of copolymer B) is from 3:1 to 1:5, preferably from 2:1 to 1:3, particularly preferably from 3:2 to 1:2.

The preparation of the polymer dispersion according to the invention can be carried out in a manner known per se, for example by means of multi-stage emulsion polymerisation. Advantageously, it is carried out by a fed-batch process, in which water, emulsifier and optionally a small amount of initiator are first placed in a reaction vessel. The initial charge preferably contains from 40 to 80 parts by weight water, based on the total amount of water, from 0.1 to 1.5 parts by weight emulsifier, based on the solids, and optionally from 0.01 to 0.3 wt. % initiator, based on the solids, the sum of the indicated parts by weight being 100.00 parts by weight. The metered addition of a small amount, preferably from 1 to 10 wt. %, of the monomers is then carried out, optionally with the simultaneous metered addition of the initiator, preferably from 0.01 to 0.3 wt. %, to form an internal seed on which the further polymerisation steps are carried out.

The monomers for copolymer A) (core) are then added stepwise to the internal seed in the mentioned ratios, and polymerisation is carried out to a conversion of at least 5.0 wt. %, preferably at least 90.0 wt. %, particularly preferably at least 95.0 wt. %, most particularly preferably at least 99 wt. %, in each case based on their total weight, the monomers for copolymer B) are added in the indicated ratios and polymerisation is carried out to a conversion of at least 85.0 wt. %, preferably at least 90.0 wt. %, particularly preferably at least 95.0 wt. %, most particularly preferably 99 wt. %, in each case based on their total weight. The emulsion polymerisation is generally carried out at a temperature of from 30 to 100° C., preferably from 50 to 90° C.

The present invention accordingly also provides a process for the preparation of the polymer dispersion according to the invention, characterised in that water, emulsifier and optionally a small amount of initiator are first placed in a reaction vessel, then the metered addition of an amount of monomers a) to c), preferably a) and b), of from 1 to 10 wt. % is carried out, optionally with the simultaneous metered addition of the initiator, to form an internal seed, and monomers a) to c) for copolymer A) (core) are then added stepwise to the internal seed and polymerised to a conversion of at least 5.0 wt. %, in each case based on their total weight, and monomers a) to c) for copolymer B) are added and polymerised to a conversion of at least 85.0 wt. %, in each case based on their total weight.

Initiation of the polymerisation is carried out by means of the initiators conventionally used for free radical polymerisation. These include, for example, hydrogen peroxide, hydroperoxides, such as tert-butyl hydroperoxide, dialkyl peroxides, such as di-tert-butyl peroxide, diacyl peroxides, peroxy esters, peroxy carbonates, peroxy dicarbonates and peroxy ketals. Also suitable are water-soluble inorganic persulfates, such as, for example, ammonium or sodium persulfate. In addition, azo initiators, such as, for example, azodiisobutyronitrile, can also be used. The initiators can be used in the form of redox initiators by addition of suitable reducing agents. Suitable reducing agents are, for example, sodium disulfite, sodium formaldehyde or isoascorbic acid. The polymerisation usually takes place in the presence of from 0.05 wt. % to 2.0 wt. %, preferably from 0.2 to 0.8 wt. %, initiator, based on the solids. Inorganic persulfates or hydroperoxides having a concentration of from 0.2 to 0.8 wt. %, based on the solids, are preferably used.

Stabilisation of the dispersions is effected inter alia by means of ionic and/or non-ionic emulsifiers and/or protective colloids. Suitable ionogenic emulsifiers are especially anionic emulsifiers. These can be the alkali or ammonium salts of alkyl, aryl or alkylaryl sulfonates, phosphates, phosphonates or compounds having other anionic end groups, wherein oligo- or poly-ethylene oxide units can also be located between the hydrocarbon radical and the anionic group. Typical examples are sodium lauryl sulfate, sodium lauryl diglycol sulfate, sodium decyl glycol ether sulfate, sodium octylphenol glycol ether sulfate and sodium dodecylbenzene sulfate.

Non-ionic emulsifiers are usually alkyl polyglycol ethers, such as ethoxylation products of lauryl, oleyl or stearyl alcohol or of mixtures such as coconut fatty alcohol. Also suitable are alkylphenol polyglycol ethers, such as ethoxylation products of octyl- or nonyl-phenol, diisopropylphenol, triisopropylphenol, di- or tri-tert-butylphenol. In addition to the mentioned classes of compounds, ethoxylation products of propylene oxide can also be used.

As suitable protective colloids there are used natural substances such as gum arabic, starch, alginates or modified natural substances such as methyl, ethyl, hydroxyalkyl or carboxymethyl cellulose or synthetic substances such as polyvinyl alcohol or modified polyvinyl alcohols or polyvinylpyrrolidone.

The emulsifiers can also be so modified, by means of an appropriate functionalisation, that they copolymerise radically with the monomers (surfiner).

It is further possible also to use mixtures of the mentioned emulsifiers.

There is preferably used as emulsifier an alkyl phosphate ester, such as, for example, phosphate esters of non-ionic and polyoxyethylene adducts (obtainable under the name Dextrol OC® from Hercules, USA). The total amount of emulsifier, based on the solids, is from 0.3 to 1.5 wt. %, preferably from 0.3 to 1.0 wt. %.

The emulsion polymerisation is generally carried out at from 30 to 100° C., preferably from 50 to 90° C. The polymerisation medium can consist either only of water or of mixtures of water and liquids miscible therewith, such as methanol. Preferably only water is used. The emulsion polymerisation can be carried out both as a batch process and in the form of a fed-batch process, including step or gradient procedure; the fed-batch process is preferred. In the fed-batch process, the polymerisation is carried out with a comparatively small monomer cushion, one or more monomers in pure or emulsified form and the mostly water-soluble auxiliary substances being metered in continuously, stepwise or in the form of a gradient via a plurality of spatially separate feeds. Adjustment of the particle size takes place via the in situ formation of an internal seed, the particle size of the seed being determined by the ratio of emulsifier to monomer. It is also possible to control the particle size by first introducing an external seed of a defined particle size. In order to prepare the core-shell particles according to the invention, stepwise metering of at least two different monomer mixtures is carried out. The monomers of the monomer mixture of the 1st or 2nd stage are preferably polymerised to the extent of at least 90 wt. %, particularly preferably at least 95 wt. % and most particularly preferably at least 99 wt. %, before the addition of the monomers of the next stage is begun.

The manner in which the initiator is added to the polymerisation vessel during the radical aqueous emulsion polymerisation is known to the person skilled in the art. It can either all be placed in the polymerisation vessel as the initial charge, or it can be used continuously or stepwise according to its consumption in the course of the radical aqueous emulsion polymerisation. In particular, it depends on the chemical nature of the initiator system and on the polymerisation temperature. Preferably, a portion is used as the initial charge and the remainder is fed to the polymerisation zone according to its consumption.

A monomodal, narrow particle size distribution, that is to say a low polydispersity index, is obtainable by measures known to the person skilled in the art, for example by varying the amount, the metering profile and structure of the surface-active compound (emulsifier and/or protective colloids) and/or corresponding stirrer speeds.

In order to ensure complete conversion and to free the dispersion of traces of free monomer, post-activation is preferably carried out, wherein small amounts of initiator, preferably from 0.01 to 0.2 wt. %, are added. It is additionally possible to purify the dispersion by physical methods, such as, for example, by subsequent steam distillation.

The solids content of a dispersion is generally determined by the ratio of water to organic starting materials. The solids content of the polymer dispersions according to the invention is from 25 to 65 wt. %, preferably from 30 to 55 wt. %, most particularly preferably from 35 to 55 wt. %.

The viscosity of the polymer dispersions according to the invention is from 5 to 300 mPas, preferably from 10 to 150 mPas, particularly preferably from 15 to 100 mPas.

The pH value of the dispersions can be varied by adding defined amounts of a base and can be from pH 3 to 12, a pH value of from 6 to 9 being preferred. In most cases, the polymerisation is carried out in the acidic pH range and neutralisation takes place when the polymerisation is complete. It is, however, also possible to feed in a portion of the base in the course of the polymerisation in order to prevent any agglomeration. There can be used as bases the inorganic or organic bases known to the person skilled in the art, which include, for example, aqueous solutions of alkali hydroxides, ammonium hydroxide, organic amines such as triethylamine or ethyldiisopropylamine. Alkali hydroxides and ammonium hydroxide are preferred.

In order that the polymer dispersions according to the invention can be used as coating compositions having a good and uniform visual film appearance, as low a content of microcoagulum as possible is required. The formation of the microcoagulum can be suppressed by measures known to the person skilled in the art, such as stirrer geometry, stirring speed, feed time, solids content, amount, metering scheme and type of surface-active compounds used, and amount of compounds for electrostatic and/or steric stabilisation. Any microcoagulum that has formed can also be separated off by filtration.

Further conventional auxiliary substances and additives can be added to the polymer dispersions according to the invention; these include, for example, biocides, antifoams, antioxidants, UV stabilisers, film-forming aids, thickeners or cosolvents.

The polymer dispersions according to the invention can be used as a film-forming constituent of lacquers and are suitable for the coating of wood, metal, plastics, paper, leather, textiles, glass and mineral substrates, preference being given to their use in wood coatings. The dispersions according to the invention can be used in the form of clear lacquers or pigmented lacquers. It is also possible to combine the polymer dispersions according to the invention with further aqueous dispersions, including, for example, further polyacrylate, polystyrene acrylate, polyurethane, polyvinyl acetate, styrene-butadiene, acrylonitrile-butadiene, alkylene- or ethylene-vinyl acetate dispersions.

The present invention provides aqueous coating compositions containing the aqueous polymer dispersions according to the invention.

It is, however, also possible to combine the polymer dispersions according to the invention with crosslinkers C).

By combination with crosslinkers C) it is possible, depending on the reactivity or optionally blocking of the crosslinkers, to produce both one-component lacquers and two-component lacquers. One-component lacquers within the scope of the present invention are to be understood as being coating compositions in which the binder component and the crosslinker component can be stored together without a crosslinking reaction occurring to a noticeable extent or to an extent that is detrimental to subsequent application. The crosslinking reaction only takes place on application after activation of the crosslinker Activation can be brought about, for example, by raising the temperature. Two-component lacquers within the scope of the present invention are understood as being coating compositions in which the binder component and the crosslinker component must be stored in separate vessels owing to their high reactivity. The two components are not mixed until shortly before application and then generally react without additional activation. In order to accelerate the crosslinking reaction, however, catalysts can be used or higher temperatures can be applied.

Suitable crosslinkers C) are, for example, polyisocyanate crosslinkers, amide- and amine-formaldehyde resins, phenolic resins, aldehyde and ketone resins.

Preferred crosslinkers C) are free or blocked polyisocyanates, which can optionally be hydrophilically modified, and/or at least partially hydrophilically modified, unblocked polyisocyanates.

The polyisocyanate is preferably at least partially hydrophilically modified.

Suitable polyisocyanates are difunctional isocyanates such as, for example, isophorone diisocyanate, hexamethylene diisocyanate, 2,4- and 2,6-diisocyanatotoluene, 4,4′-diphenylmethane diisocyanate and/or higher molecular weight trimers thereof, biurets, urethanes, iminooxadiazinedione and/or allophanates. Particular preference is given to the use of low viscosity, optionally hydrophilised polyisocyanates of the above-mentioned type based on aliphatic or cycloaliphatic isocyanates.

For blocking, the above-mentioned polyisocyanates are reacted with blocking agents such as, for example, methanol, ethanol, butanol, hexanol, benzyl alcohol, acetoxime, butanoneoxime, caprolactam, phenol, diethyl malonate, diethyl malonate, dimethylpyrazole, triazole, dimethyltriazole, acetoacetic ester, diisopropylamine, dibutylamine, tert-butylbenzylamine, cyclopentanonecarboxyethyl ester, dicyclohexylamine and/or tert-butylisopropylamine.

The unblocked and blocked polyisocyanates can also be converted into a water-dispersible form by the incorporation of hydrophilic groups, such as, for example, carboxylate, sulfonate and/or polyethylene oxide structures, and thus used in combination with the preparations according to the invention. The mentioned blocked polyisocyanates can also be prepared with the concomitant use of hydroxy- or amino-functional, also higher molecular weight components, such as, for example, diols, triols, amino alcohols, polyesters, polyethers, polycarbonates and mixtures of the mentioned and/or other raw materials.

The polyisocyanates used as crosslinkers C) generally have a viscosity of from 10 to 5000 mPas at 23° C. and, if desired in order to adjust the viscosity, can also be used in admixture with small amounts of inert solvents.

In principle it is, of course, also possible to use mixtures of different crosslinkers C).

The present invention likewise provides the use of the aqueous polymer dispersions according to the invention in the production of coatings. Coating is preferably carried out on wood or derived timber products as substrate.

### EXAMPLES

### Chemicals

Acrylic acid (ACA), CAS 79-10-7, Aldrich, DE
Methyl methacrylate (MMA), CAS 80-62-6, Aldrich, DE

### Styrene (S), CAS 100-42-5, Aldrich, DE

n-Butyl acrylate (BA), CAS 141-32-2, Aldrich, DE
Ammonium persulfate (APS), CAS 7727-54-0, Aldrich, DE

### Emulsifier Tannemul® 951 (E951), CAS 68610-22-0, Tanatex, DE

Emulsifier Dextrol OC® 40 (PHT), mixture of CAS 009046-01-9 (>25%), CAS 024938-91-8 (<10%), CAS 007664-38-2 (<10%), Hercules, USA
BYK® 341, surface additive, BYK Chemie, DE
BYK® 348, wetting agent, BYK Chemie, DE
BYK® 028, antifoam, BYK Chemie, DE
Dehydran® 1620, antifoam, Cognis, De
Acrylsol® RM-8 W, thickener, Rohm & Haas, USA

### Methods:

### Glass Transition Temperature Calculated:

The glass transition temperature is calculated according to the Fox equation (Bulletin of the American Physical Society 1, 3, page 123, 1956):

$$\frac{1}{{T}_{g}} = \frac{{w}_{1}}{{T}_{g ( 1 )}} + \frac{{w}_{2}}{{T}_{g ( 2 )}} + … \frac{{w}_{i}}{{T}_{g ( i )}} + … \frac{{w}_{n}}{{T}_{g ( n )}}$$

wherein T_{g(i)} denotes the glass transition temperature of the respective homopolymer i of n monomers and wᵢ denotes the amount by weight of the monomer i, wherein the sum of all the amounts by weight w₁+w₂+ . . . wᵢ+ . . . wₙ=1.

### Particle Size:

The mean particle size (MPS) was determined by means of laser correlation spectroscopy (device: Malvern Zetasizer 1000, Malvern Instruments LTD); the number averages are given.

### Solids:

The solids content was determined according to DIN-EN ISO 3251.

### Viscosity:

The viscosity is determined using conventional Brookfield viscometers at RT as specified by the device manufacturer.

### Pendulum Hardness:

The pendulum hardness according to König was measured according to DIN 53157.

### Visual Film Appearance:

A visual evaluation of the lacquer film was carried out, high numbers representing a poor visual appearance.

### Film Haze:

The haze was measured according to DIN EN ISO 13803 using a haze gloss meter from BYK Gardner.

### Ethanol Resistance:

The coatings are brought into contact with a cotton swab soaked with ethanol, and covered with a Petri dish. The substance is allowed to act for 30 minutes and then the coating is left for three days, after which a visual assessment is carried out, high numbers indicating poor resistance.

### Other Resistance (Red Wine, Mustard and Coffee):

The procedure described under the section Ethanol resistance is followed, but the duration of action is 16 hours.

### Preparation of the Dispersions:

In the following section, a general synthesis procedure for the preparation of the dispersions according to the invention is described; the specific compositions of the individual tests are to be found in Table 1.

### General Synthesis Procedure:

52 parts of water are placed with the corresponding amount of emulsifier E1 in a 3-litre glass reactor having controlled heating and cooling and a stirring motor. The solution is then heated to 80° C. When the polymerisation temperature has been reached, the monomer mixture M1 and the initiator solution W1 for the preparation of the internal seed are added in the course of 30 minutes via a metering pump, after which stirring is carried out for a further 30 minutes. The monomer mixture M2 of the core and the aqueous solution W2 are then metered in at 80° C. in the course of 120 minutes. The addition of the monomer mixture M3 of the shell and of the aqueous solution W3 is then carried out within a period of 120 minutes. Immediately after the metered additions of M3 and W3, 0.05 part of APS in 5 parts of water are metered in in the course of 60 minutes for post-activation, and the dispersion is stirred further for a period of 60 minutes and then cooled. In order to adjust the pH to pH 7, the corresponding amount of ammoniacal solution is slowly added dropwise and the finished dispersion is discharged over a 125 μm filter.

TABLE 1
Formulations for the preparation of the polyacrylate dispersions

| | | Test | | | | | |
|---|---|---|---|---|---|---|---|
| | | 1* | 2* | 3* | 4* | 5* | 6 |
| | | Emulsifier type | | | | | |
| | | E951 | E951 | E951 | E951 | E951 | PHT |
| Initial charge | E1 | 4.7 | 4.7 | 4.7 | 4.7 | 4.7 | 4.5 |
| M1 | MMA/g | 14.1 | 27.6 | 21.6 | 14.0 | 11.3 | 14.1 |
| | BA/g | 2.5 | 3.0 | 3.0 | 31.6 | 2.5 | 2.5 |
| | S/g | 14.0 | 31.0 | 21.0 | 16.0 | 14.0 | 14.0 |
| W1 | APS/g | 0.5 | 0.5 | 0.5 | 0.5 | 0.5 | 0.5 |
| | Water | 18.0 | 18.0 | 18.0 | 18.0 | 18.0 | 22.0 |
| M2 | MMA/g | 123.0 | 247.0 | 192.0 | 135.0 | 107.0 | 123.0 |
| | BA/g | 14.0 | 30.0 | 22.0 | 270.0 | 14.0 | 14.0 |
| | S/g | 130.0 | 275.0 | 196.0 | 147.0 | 130.0 | 130.0 |
| | ACA/g | 9.4 | 9.4 | 9.4 | 9.4 | 28.2 | 9.4 |
| W2 | APS/g | 2.2 | 2.2 | 2.2 | 2.2 | 2.2 | 2.2 |
| | E2/g | 2.4 | 2.4 | 2.4 | 2.4 | 2.4 | 2.5 |
| | Water/g | 300.0 | 300.0 | 300.0 | 300.0 | 300.0 | 300.0 |
| M3 | MMA/g | 149.0 | 67.0 | 108.6 | 137.1 | 181.8 | 200.6 |
| | BA/g | 301.6 | 148.6 | 225.0 | 16.5 | 230.0 | 230.0 |
| | S/g | 163.0 | 82.0 | 122.0 | 144.0 | 183.0 | 183.0 |
| | ACA/g | 9.4 | 9.4 | 9.4 | 9.4 | 28.2 | 9.4 |
| W3 | APS/g | 2.2 | 2.2 | 2.2 | 2.2 | 2.2 | 2.2 |
| | E3/g | 2.4 | 2.4 | 2.4 | 2.4 | 2.4 | 2.5 |
| | Water/g | 300.0 | 300.0 | 300.0 | 300.0 | 300.0 | 300.0 |

Test

| | | | |
|---|---|---|---|
| 7 | 8 | 9 | 10* |

Emulsifier type

| | | PHT | PHT | PHT | PHT |
|---|---|---|---|---|---|
| Initial charge | E1 | 2.4 | 2.4 | 2.4 | 2.4 |
| M1 | MMA/g | 14.1 | 14.1 | 14.1 | 14.1 |
| | BA/g | 2.5 | 2.5 | 2.5 | 2.5 |
| | S/g | 14.0 | 14.0 | 14.0 | 14.0 |
| W1 | APS/g | 0.5 | 0.5 | 0.5 | 0.5 |
| | Water | 22.0 | 22.0 | 22.0 | 22.0 |
| M2 | MMA/g | 123.0 | 123.0 | 123.0 | 123.0 |
| | BA/g | 14.0 | 14.0 | 14.0 | 14.0 |
| | S/g | 130.0 | 125.3 | 120.6 | 115.9 |
| | ACA/g | 9.4 | 14.1 | 18.8 | 23.5 |
| W2 | APS/g | 2.2 | 2.2 | 2.2 | 2.2 |
| | E2/g | 1.2 | 1.2 | 1.2 | 1.2 |
| | Water/g | 300.0 | 300.0 | 300.0 | 300.0 |
| M3 | MMA/g | 200.6 | 200.6 | 200.6 | 200.6 |
| | BA/g | 230.0 | 230.0 | 230.0 | 230.0 |
| | S/g | 183.0 | 178.3 | 173.6 | 168.9 |
| | ACA/g | 9.4 | 14.1 | 18.8 | 23.5 |
| W3 | APS/g | 2.2 | 2.2 | 2.2 | 2.2 |
| | E3/g | 1.2 | 1.2 | 1.2 | 1.2 |
| | Water/g | 300.0 | 300.0 | 300.0 | 300.0 |

*Comparison example

TABLE 2
Properties of the dispersions

Test

| | 1* | 2* | 3* | 4* | 5* | 6 |
|---|---|---|---|---|---|---|
| FSG/% | 39.8 | 39.8 | 39.7 | 40.0 | 39.8 | 39.9 |
| pH | 6.3 | 6.2 | 6.1 | 6.0 | 6.7 | 7.4 |
| MPS/nm | 99 | 110 | 106 | 97 | 97 | 101 |
| Viscosity/ | 20 | 20 | 20 | 20 | 50 | 25 |
| mPas | | | | | | |

Test

| | 7 | 8 | 9 | 10* |
|---|---|---|---|---|
| FSG/% | 39.7 | 39.9 | 39.9 | 38.2 |
| pH | 7.1 | 6.8 | 6.8 | 6.9 |
| MPS/nm | 117 | 110 | 121 | 93 |
| Viscosity/ | 15 | 15 | 15 | 15 |
| mPas | | | | |

### Formulation of the Dispersions:

In the following section, a general procedure for the formulation of the exemplary dispersions is shown; the weighed amounts are to be found in Table 3.

The dispersion is placed in a vessel and stirred. Then BYK 341 and BYK 348 are added at a stirring speed of 2 m/s, and stirring is carried out for 10 minutes. The addition of the antifoam Dehydran 1620 is then carried out at a stirring speed of 2 m/s and stirring is carried out for 5 minutes, and then BYK 028 is added at a stirring speed of 2 m/s and stirring is carried out for a further 5 minutes. This is followed by the addition of the cosolvent butyl diglycol in a 1:1 mixture with water at a stirring speed of from 1 to 1.5 m/s, stirring is carried out for 5 minutes, and finally the thickener is added at a stirring speed of from 0.5 to 1 m/s, the formulation being stirred again for 5 minutes. The amount of thickener is so adjusted that the runout time is about 25 seconds (DIN-4 beaker).

TABLE 3
Composition of the formulations used

| | |
|---|---|
| Dispersion from examples/% | 82.9 |
| BYK 341/% | 0.4 |
| BYK 348/% | 0.5 |
| Dehydran 1620/% | 0.2 |
| BYK 028/% | 0.8 |
| Butyl diglycol/water (1:1)/% | 14.3 |
| Acrysol RM-8 W/% | about 0.9 |

### Application of the Formulations and Results:

The formulations are applied to an MDF sheet by means of a manual doctor blade in a wet layer thickness of 200 μm, and then drying is carried out for 24 hours at room temperature. The results of the test are to be found in Table 4:

TABLE 4
Results of the application tests

Test

| | 1* | 2* | 3* | 4* | 5* | 6 |
|---|---|---|---|---|---|---|
| T_{g} overall calc./ | 35 | 60 | 50 | 35 | 48 | 48 |
| ° C. | | | | | | |
| T_{g} core calc./° C. | 90 | 90 | 90 | 13 | 90 | 90 |
| T_{g} shell calc./° C. | 13 | 13 | 13 | 90 | 30 | 30 |
| Core/wt. % | 33 | 67 | 50 | 67 | 33 | 33 |
| Shell/wt. % | 67 | 33 | 50 | 33 | 67 | 67 |
| Pendulum | 36 | 55 | 46 | 52 | 64 | 51 |
| hardness/sec. | | | | | | |
| Visual film | 1 | 4 | 3 | 1 | 1 | 1 |
| appearance | | | | | | |
| Film haze | 1 | 4 | 3 | 1 | 1 | 1 |
| EtOH resistance | 4 | 2 | 3 | 4 | 4 | 2 |
| Coffee resistance | 1 | 1 | 1 | 1 | 1 | 1 |
| Wine resistance | 1 | 1 | 1 | 1 | 1 | 1 |
| Mustard | 4 | 3 | 3 | 4 | 4 | 2 |
| resistance | | | | | | |

Test

| | 7 | 8 | 9 | 10* |
|---|---|---|---|---|
| T_{g} overall calc./ | 48 | 48 | 48 | 48 |
| ° C. | | | | |
| T_{g} core calc./° C. | 90 | 90 | 90 | 90 |
| T_{g} shell calc./° C. | 30 | 30 | 30 | 30 |
| Core/wt. % | 33 | 33 | 33 | 33 |
| Shell/wt. % | 67 | 67 | 67 | 67 |
| Pendulum | 54 | 53 | 57 | 61 |
| hardness/sec. | | | | |
| Visual film | 2 | 2 | 1 | 1 |
| appearance | | | | |
| Film haze | 1 | 1 | 1 | 1 |
| EtOH resistance | 1 | 1 | 2 | 3 |
| Coffee resistance | 1 | 1 | 1 | 1 |
| Wine resistance | 1 | 1 | 1 | 1 |
| Mustard | 1 | 1 | 2 | 3 |
| resistance | | | | |

In Table 4, the physical parameters and test results of the corresponding wood lacquers of exemplary dispersions 1 to 11 are shown. In the test results without units, the low numbers denote a positive result, high numbers denote a negative result.

It will be seen that only the dispersions according to the invention exhibit an adequate pendulum hardness of >50 seconds while at the same time having a good visual film appearance and low haze in combination with high solvent resistance.

1. Aqueous, polymer dispersion comprising at least one core copolymer A) and at least one shell copolymer B), wherein the glass transition temperature (T_{g}) of the core is from 70° C. to 100° C., the glass transition temperature (T_{g}) of the shell is from 20° C. to 55° C. and the overall glass transition temperature (T_{g}) of the core-shell copolymer is from 30° C. to 80° C., and the dispersion contains an emulsifier content in an amount of ≦1.5 wt. %, based on the solids.

2. Aqueous polymer dispersion according to claim 1, wherein the polymer particles have a mean particle size of from 75 to 140 nm.

3. Aqueous polymer dispersion according to claim 1, wherein the T_{g} of copolymer B) is at least 30° C. lower than the T_{g} of copolymer A).

4. Aqueous polymer dispersion according to claim 1, wherein the monomer mixture of copolymer A) and B) comprises
a) (meth)acrylate,
b) at least one vinyl aromatic compound having up to 20 carbon atoms,
c) at least one acid-functional monomer and
d) optionally at least one hydroxy-functional monomer.

5. Aqueous polymer dispersion according to claim 1, wherein the content of monomer a) in copolymer A) is from 20 to 80 wt. %, the content of monomer b) is from 19 to 79 wt. %, the content of monomer c) is from 1 to 10 wt. %, and the content of monomer d) is <30 wt. %, the sum of components a), b), c) and optionally d) being 100 wt. %.

6. Aqueous polymer dispersion according to claim 1, wherein the content of monomer a) in copolymer B) is from 35 to 90 wt. %, the content of monomer b) is from 9.9 to 60 wt. %, the content of monomer c) is from 0.1 to 3.7 wt. %, and the content of monomer d) is <30 wt. %, the sum of components a), b), c) and optionally d) being 100 wt. %.

7. Aqueous polymer dispersion according to claim 1, wherein the weight ratio of the monomer of copolymer A) to the monomer of copolymer B) is from 3:1 to 1:5.

8. Aqueous polymer dispersion according to claim 1, wherein the emulsifier is an alkyl phosphate ester.

9. Process for the preparation of the polymer dispersion, wherein water, emulsifier and optionally a small amount of initiator are first placed in a reaction vessel, then a metered addition of an amount of monomers a) to c) of from 1 to 10 wt. % is carried out, optionally with the simultaneous metered addition of the initiator, to form an internal seed, and monomers a) to d) for copolymer A) (core) are then added stepwise to the internal seed and polymerised to a conversion of at least 5.0 wt. %, in each case based on their total weight, and monomers a) to d) for copolymer B) are added and polymerised to a conversion of at least 85.0 wt. %, in each case based on their total weight.

10. Aqueous coating composition comprising an aqueous polymer dispersions according to claim 1.

11. An aqueous polymer dispersion according to claim 1 capable of being used in the production of a coating on a substrate.

12. Dispersion according to claim 11, wherein the substrate comprises wood or derived timber products.
